(19) United States
(12) Patent Application Publication
(10) Pub. No.: US 2017/0152168 A1
(43) Pub. Date: Jun. 1, 2017

(54) LOW-PRESSURE AERATION TREATMENT OF BIOLOGICAL WASTEWATER

(71) Applicant: ClearBakk Energy Services Ltd., Calgary (CA)

(72) Inventors: Teunis CLOETE, Calgary (CA); Ruth ROXBURGH, Calgary (CA); Lisheng LI, Calgary (CA)

(73) Assignee: ClearBakk Energy Services Ltd., Calgary (CA)

(21) Appl. No.: 14/955,598

(22) Filed: Dec. 1, 2015

(51) Int. Cl. C02F 3/12; C02F 1/44; C02F 11/02; C02F 3/20

(52) U.S. Cl. CPC C02F 3/1278; C02F 3/20; C02F 1/44; C02F 11/02; C02F 2203/006; C02F 2209/03

(57) ABSTRACT

Described are a method and apparatus for the biological treatment of wastewater in an activated sludge process that use a primary separator to produce a pretreated wastewater, a pressurized aeration tank which has a headspace pressure of between about 1 and about 10 psi, and a secondary separator to separate mixed liquor from the aeration tank into an activated sludge component and a clarified liquor component. The aeration tank has a rectangular or square base and may be cuboid. Embodiments contemplate making a package plant, and may use a screening tank, a membrane separator, air eductors to aerate a return activated sludge, and multiplier nozzles to introduce the return activated sludge into the aeration tank. The apparatus has a small footprint, is simple in design, and is low maintenance.

### FIELD

This description relates to a method and apparatus for the treatment of wastewater. More particularly, it relates to the use of a low pressure aeration system to improve the oxygen transfer efficiency and means to generate this low pressure in a pressurized aeration tank.

### BACKGROUND

Wastewater treatment facilities prepare wastewater, such as sewage or industrial waste, for return to the water cycle. Treatment facilities generally practice several steps in treating the wastewater, such as screening, degritting, sedimentation, floatation, clarification, filtration, biological treatment, disinfection and/or sludge stabilization, to name a few.

Biological treatment is used to remove soluble and colloidal organics that pass through the primary treatment of the water. Common biological waste treatment processes fall into three major groups: aerobic, anaerobic and biological nutrient removal. Aerobic wastewater treatment that maintains a population of microorganisms in suspension and in the presence of oxygen is typically called the “activated sludge process”. The activated sludge process involves the introduction of air or oxygen into a mixture of primary treated sewage or industrial wastewater that contain microorganisms such as bacteria and protozoans, to develop a biological floc (biomass), thereby reducing the organic content in the wastewater.

In the activated sludge process, soluble and colloidal organics, nutrients and other substances in the wastewater are consumed by the microorganisms, and a sufficient supply of oxygen is required by the microorganisms to maintain the required microbial activity. Biochemical oxygen demand, or BOD, is the amount of dissolved oxygen needed by the microorganisms to break down organic materials present in a given water sample at certain temperature over a specific time period. A BOD value for wastewater may be expressed as the mg O₂ consumed per litre of sample, during 5 days of incubation at 20° C. (BOD₅), and is a measure of the organic loading of the wastewater. Once the wastewater has received sufficient treatment the solid material, or sludge, is separated from the liquid and these two components may be further processed, discarded or recycled back into the treatment system.

Thus, biological treatment reduces the organic content in the wastewater stream. Oxygen transfer efficiency is critical to this process. The oxygen transfer efficiency, that is, the efficiency with which oxygen (O₂) dissolves into a liquid, is predominantly dependent on bubble size, pressure, temperature and contact time. Increasing the pressure of the system will increase the oxygen transfer efficiency according to Henry's law, and therefore some treatment facilities use pressurized tanks to decrease footprint, as a pressurized tank can achieve better oxygen transfer efficiency than a similarly-sized non-pressurized tank.

An aerobic wastewater treatment facility typically includes: (a) an aeration tank that holds the wastewater and microorganisms (the “mixed liquor”), (b) an oxygen source such as atmospheric or pressurized air or oxygen and equipment to disperse the oxygen through the mixed liquor, and (c) a means for separating the mixed liquor into biomass (sludge) and the treated water, after the treatment is completed.

The most common means for dispersing oxygen into the wastewater in an aeration tank is by forcing air through fine or coarse bubble diffusers into the tank using a blower. The air bubbles are introduced at the bottom of the aeration tank holding the mixed liquor and travel upwards through the mixed liquor because they have a lower density than the mixed liquor, and a small percentage of the oxygen is dissolved in or transferred to the liquid.

Other methods of introducing oxygen into mixed liquor have been described, including:

a) use of pure oxygen or an oxygen generator to introduce oxygen into mixed liquor;
b) use of primary and secondary pressure vessels (at 50-70 psi) combined with compressed air and splash plates/ejectors to atomize air into the mixed liquor. This is typical of a dissolved air flotation (DAF) system which is a mechanism used for creating bubbles upon release to atmospheric pressure in order to float solids to the top of the water (DAF is a separation technology like a clarifier and is not used for aerobic treatment);
c) use of surface aerators, which is common with pond/lagoon treatment. Surface aerators provide agitation at the surface which exposes the water to air;
d) use of jet aerators, which transfers oxygen by simultaneously introducing high kinetic energy liquid and air through a series of jet nozzles; and
e) use of vertical shaft aerator that combines mixing and aeration submerged in a tank. The shaft draws in air and the mixing energy from the rotating aerator combines to provide a mixed tank with oxygen.

Pure oxygen or oxygen generation present a safety hazard at site particularly with the use of compressed pure oxygen. It is not as cost effective as other methods, nor is it readily available in certain regions. Further, the oxygen tanks or generators take up additional space and the tanks require filling when depleted.

Use of pressures above 15 psi requires pressure vessel certification and design. In order to cost-effectively meet certification requirements, tanks are typically cylindrical in design. Compressed air is typically used as the mechanism to pressurize the tanks and requires a compressed air system separate from the pressure vessel, to accommodate this.

CA 2,598,524 entitled Aerating Wastewater for Re-Use, describes a method and apparatus that uses recirculation of the mixed liquor between primary and secondary pressurized aeration tanks that are pressurized with compressed air, and a splatter plate in the secondary tank, to aerate the mixed liquor. The mixed liquor is transferred to a settling tank or clarifier, and the solids that settle are recycled back to the aeration tank.

U.S. Pat. No. 4,369,111 entitled Activated Sludge System, describes a method and apparatus that uses a pressurized aeration tank pressurized with compressed air to 4.0-4.5 bar (58-65 psi), and a series of redans (such as plates) and the compressed air, to aerate the mixed liquor. The mixed liquor is transferred to a floatation basin where a drop in pressure takes place, producing gas bubbles that enhance the floatation.

CA 2208847 entitled Method and Apparatus for the Treatment of Concentrated Wastewater, describes a pressurized process for the treatment of high-solid wastewater having relatively high BOD and phosphorus concentration that includes anaerobic and aerobic treatment.

CA 1194623 entitled Method and Apparatus for Treating Organic Wastewater describes an apparatus that consists of three pressurized vessels linked in series by piping, and maintained at equal pressure (up to 35 psi) by means of a common manifold. Liquid flows from one vessel to another by gravity. CA 2630328 entitled Liquid Aeration Apparatus and Wastewater Treatment Apparatus relates to septic tank systems that uses an attached growth, fixed film process, and more particularly to a vessel used therein that has an air diffuser and a liquid intake at specific positions on the vessel.

U.S. Pat. No. 6,752,926 entitled Method and Apparatus for Treatment of Wastewater describes a closed bioreactor into which oxygen is provided by diffusion through a non-porous hydrophobic membrane in a recirculation line. The bioreactor is operated as a closed unit at elevated pressures. EU 0058225 entitled Pressurized Aeration Tank for Activated-Sludge Process Sewage Treatment describes a pressurized aeration tank (42-85 psi) that uses an axial-flow impeller pump to mechanically agitate the mixed liquor.

Package plants are pre-manufactured wastewater treatment facilities, for use in areas with a limited number of people and small wastewater flows. They are commonly used in small communities or in isolated locations, for example, trailer parks, hospitals, prisons, construction camps and remote camps for resource industries (oil & gas, mining, forestry). There is a continuing need to reduce their footprint and the costs associated with building and operating the plants. Plants intended to be used in remote locations have the added complications that monitoring, maintenance and repair are difficult, and they may need to be operational under extreme weather conditions. Minimizing footprint can also be a concern for municipal wastewater treatment plants. They are often in residential areas with limited room for expansion. There is therefore an interest in wastewater treatment systems and methods which have a smaller footprint, are cost-effective, and are easy to maintain.

### SUMMARY

Motivated by the considerations of reducing cost, footprint, energy consumption and maintenance requirements, described herein is a wastewater treatment method and apparatus that uses the activated sludge process and an aeration tank that is pressurized a low pressure. Also described are low-maintenance and energy-efficient components of the method and apparatus that promote aeration of the mixed liquor, and the maintenance of the low pressure, in the tank.

In one aspect, described herein is an apparatus for the biological treatment of wastewater in an activated sludge process comprising:

a) a primary separator that produces a pretreated wastewater with large solids removed;
b) a conduit for transporting the pretreated wastewater to a pressurized aeration tank which has a headspace pressure of between about 1 and about 10 psi;
c) means for aerating and agitating a mixed liquor in the aeration tank; and
d) a conduit for transporting the mixed liquor to a secondary separator, for separating the mixed liquor into an activated sludge component and a clarified liquor component.

The aeration tank may have a rectangular or square base. In some embodiments the aeration tank is cuboid.

In some embodiments the aeration tank is pressurized to the headspace pressure by a pump that pumps the pretreated wastewater into the aeration tank.

In some embodiments the primary separator is a screening tank. In some embodiments the secondary separator is a membrane separator, and the apparatus further comprises a pump that pumps the mixed liquor to the membrane separator.

In some embodiments the apparatus further comprises a return path along which at least a portion of the activated sludge component is recirculated back to the aeration tank. The return path may comprise at least one air eductor that aerates the portion of the activated sludge component that is recirculated back to the aeration tank.

In some embodiments the means for aerating and agitating a mixed liquor in the aeration tank is a diffused air system. The diffused air system may comprise at least one multiplier nozzle.

In another aspect, described herein is a method for the biological treatment of wastewater using the activated sludge process, which comprises the steps of:

a) delivering a pretreated wastewater stream into a pressurized aeration tank that has a headspace pressure of between about 1 and about 10 psi;
b) aerating and agitating a mixed liquor in the aeration tank; and
c) maintaining the mixed liquor in the pressurized aeration tank for a period of time sufficient for microorganisms in the wastewater to consume soluble and colloidal organics, nutrients and other substances in the mixed liquor.

In some embodiments the aeration tank has a rectangular or square base. In some embodiments the aeration tank is cuboid.

The method may further comprise the steps of: (a) generating the headspace pressure in the tank by pumping the wastewater stream into the aeration tank, and (b) maintaining the headspace pressure at less than about 10 psi with at least one backpressure regulator.

The method may further comprising the steps of:

a) after the period of time, transporting the mixed liquor from the pressurized aeration tank to a secondary separator;
b) separating the mixed liquor to produce an activated sludge component and a clarified liquor effluent;
c) aerating at least a portion of the activated sludge component to produce aerated activated sludge; and

delivering the aerated activated sludge to the pressurized aeration tank.

In some embodiments the portion of the activated sludge is aerated with at least one air eductor.

In another aspect described herein is a method for the biological treatment of sewage using the activated sludge process, which comprises the steps of:

a) passing primary raw sewage through a screening tank to produce a pretreated sewage stream;
b) pumping the pretreated sewage stream into an aeration tank that is pressurized to a pressure of between about 1 and about 10 psi;
c) aerating and agitating a mixed liquor in the aeration tank;
d) discharging the mixed liquor from the aeration tank;
e) separating the discharged mixed liquor into an activated sludge component and a clarified liquor component;
f) aerating at least a portion of the activated sludge component, to form an aerated activated sludge; and
g) delivering the aerated activated sludge to the aeration tank.

In one embodiment the step of separating the discharged mixed liquor is performed by membrane separation. In some embodiments the step of aerating a portion of the activated sludge component is performed by directing the portion of the activated sludge through at least one air eductor. In some embodiments the aerated activated sludge is introduced into the aeration tank through at least one multiplier nozzle disposed in the aeration tank.

In another aspect described herein is a method for pressurizing an aeration tank used in the biological treatment of wastewater with the activated sludge process to a pressure of between about 1 psi and about 10 psi in the headspace, comprising the steps of:

a) pumping the wastewater into the aeration tank to pressurize the tank to a pressure greater than about 1 psi, and
b) maintaining the pressure in the headspace of the aeration tank below about 10 psi with at least one backpressure regulator.

In some embodiments the aeration tank has a rectangular or square base. In some embodiments the aeration tank is cuboid.

In another aspect, described herein is a method of increasing the dissolved oxygen content of a mixed liquor in an aeration tank comprising:

a) drawing external air into a pressurized flow stream with air eductors, to generate an aerated pressurized flow stream;
b) injecting the aerated pressured flow stream into the mixed liquor through injection nozzles, to physically mix the aerated pressurized flow stream with the mixed liquor; and
c) circulating the aerated pressurized flow stream through the injection nozzles at a high rate.

### BRIEF DESCRIPTION OF THE DRAWINGS

FIG. 1 is a drawing of an embodiment of the steps of the wastewater treatment method described herein.

FIG. 2 is a drawing of an embodiment of the wastewater treatment apparatus described herein.

FIG. 3 is a drawing of an embodiment of the wastewater treatment method described herein.

### DETAILED DESCRIPTION

A wastewater treatment plant that has a reduced footprint, is low-maintenance, and energy-efficient is desirable. The inventors have designed a wastewater treatment plant which uses the activated sludge process, motivated by the considerations of reducing cost, footprint, energy consumption and maintenance requirements. The method and apparatus described herein can treat many kinds of wastewater including sewage, liquid agricultural and industrial waste, and is particularly suitable for use as a package plant.

Non-pressurized aeration tanks are the industry standard in wastewater treatment facilities, however, compared to high-pressure aeration tanks they have a significantly larger footprint and are not ideal for use in treatment plants that need to be small, portable or that are limited by expansion space. While it would be desirable to use a high-pressure aeration tank to decrease footprint while achieving the same oxygen transfer efficiency, these types of tanks are more expensive to manufacture than are non-pressurized tanks, they require certification, and they are more onerous to maintain. For remote areas, it is important to minimize the need to perform routine and urgent maintenance on a wastewater treatment plant.

High-pressure aeration tanks used in the activated sludge process are operated at a pressure of greater than about 15 psi in the headspace. These tanks require the use of ancillary devices to maintain these high pressures, such as compressed air/oxygen tanks, compressors or pressure boosting pumps, which also add to cost and increase maintenance burden. Therefore, it is desirable to avoid using high-pressure aeration tanks if reducing cost and maintenance burden are the objectives.

Described herein is a wastewater treatment method and apparatus that is pressurized to improve oxygen transfer efficiency (as compared to non-pressurized/atmospheric tanks), but that does not use a high-pressure aeration tank. Tanks intended for use at pressures above about 15 psi need to be certified. The tank used in the presently-described wastewater treatment method and apparatus is designed for use at pressures of below about 15 psi, and is used in the methods described at above atmospheric pressure and below a pressure of about 10 psi in the headspace.

High-pressure aeration tanks are typically cylindrical, because tanks with curved sides have greater structural stability than tanks with a planar sides, such as cuboid tanks. A tank with planar sides would need to be reinforced to meet certification requirements, thus a cylindrical tank is less expensive to manufacture for high-pressure applications. Because the low-pressure tank used herein does not need to be certified, a cuboid tank with a rectangular or square base, which has several advantages over a cylindrical tank, may be used. For essentially equivalent footprints, a cuboid tank can hold a greater volume of wastewater, and the surface area of the wastewater in the tank is greater, therefore an equalization or holding tank is not needed (reducing footprint some more). Circular tanks may be used in the methods and apparatus herein if there is existing tankage that can be used for aeration, if space is not a problem, or if other site conditions require it.

Another benefit of using a low-pressure aeration tank is that compressed air tanks or compressors do not need to be used to pressurize the tank, saving on cost and maintenance. However, in the methods and apparatus described herein it is still necessary to pressurize the tank to above atmospheric pressure and up to a pressure of about 10 psi.

The aeration step in the activated sludge processes, whether in a pressurized or non-pressurized tank, is commonly one of the most energy-demanding processes of the entire system, consuming as much as 50 to 90% of the total energy costs of a typical treatment facility. Reducing energy consumption during aeration is usually the best initial step to minimize energy costs. Further, using a low-maintenance means of aeration is desirable in wastewater treatment plants that are intended for remote use.

Accordingly, the inventors have determined that there is a lower pressure that can be used in an aeration tank in the activated sludge process which provides a significant improvement in oxygen transfer efficiency over a non-pressurized tank and a meaningful reduction in footprint size. The inventors have further identified means for pressurizing and aerating this low-pressure tank that are cost-effective, low maintenance and that have a small footprint. The wastewater treatment method and apparatus described herein are therefore ideal for package plants (particularly those used in remote locations), or for retrofitting aeration tanks in municipal or industrial plants to increase capacity and efficiency without requiring additional space and/or construction of new tanks.

Method

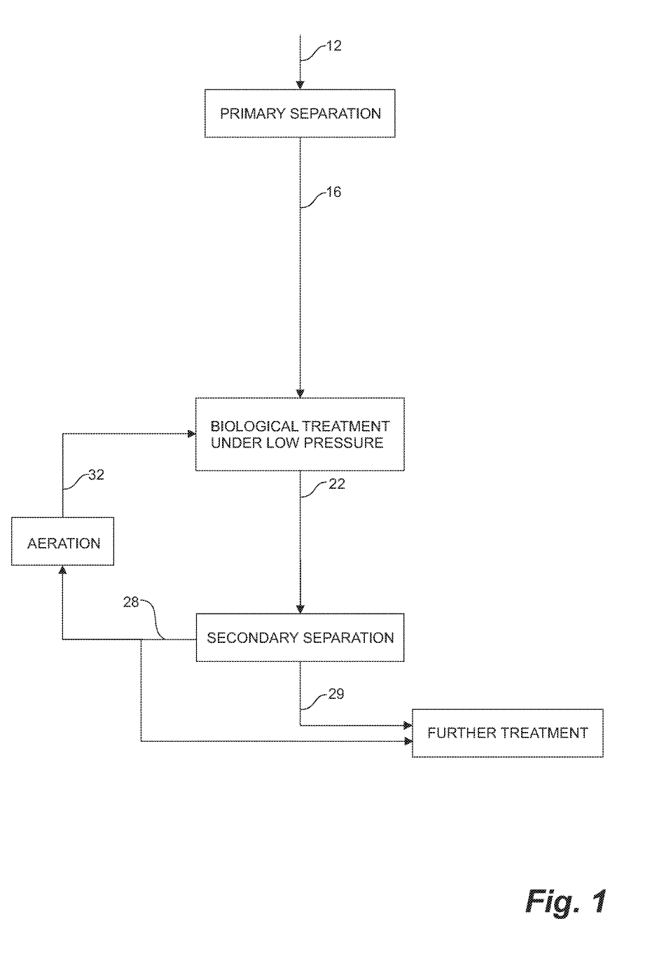

FIG. 1 shows a schematic of an embodiment of the wastewater treatment method described herein. A wastewater stream 12 is subjected to a primary separation step to provide a pre-treated wastewater stream 16 that is delivered to an aeration tank, where it undergoes biological treatment at a low pressure. A pump may be used to deliver the pre-treated wastewater stream to the aeration tank. The mixed liquor is agitated and aerated in the aeration tank. Mixed liquor 22 is subjected to a secondary separation step to separate it into a clarified liquor effluent component 29 containing suspended solids (biosolids) and an activated sludge 28 component. A pump may be used to transfer the mixed liquor to the secondary separator.

All, or a portion of, the activated sludge 28 may then be recirculated back to the biological treatment step, and the recirculated or return activated sludge may be aerated along the recirculation path to form an aerated activated sludge 32 that is delivered to the aeration tank to aerate and agitate the mixed liquor therein. The clarified liquor effluent component 29, and any waste activated sludge 28 may then be further treated and/or released to the environment.

“Wastewater”, as used herein refers to water that is no longer needed or suitable for its most recent use, and that must therefore be treated before release back to the water cycle, or before re-use. Non-limiting examples of wastewater as contemplated herein are sewage (e.g., household waste), liquid agricultural and industrial waste.

Primary separation is performed to remove large particulate matter which could damage components of the treatment facility, if not removed. Primary separation methods that may be used include, without limitation, screening, grit removal, sedimentation and floatation. Preferred is the use of screening for the primary separation step.

Biological treatment is performed in a pressurized aeration tank at a “low pressure”, which as used herein means a pressure of between about 1 psi and about 10 psi, preferably between about 3 psi and about 9 psi, and most preferably between about 5 psi and about 7 psi.

The pressure in the aeration tank may be generated at least in part, by the action of a pump, which pumps the pretreated wastewater 16 into the aeration tank, and/or by the use of air eductors, compressed air or oxygen, compressors, pressure boosting pumps, blowers and the like. The pressure in the tank may be kept below a maximum predetermined pressure by at least one backpressure regulator, for example a pressure control valve, a pressure vacuum relief valve or a pressure reducing valve.

The secondary separation step separates the mixed liquor 22 from the aeration tank into an activated sludge component 28 and a clarified liquor effluent 29. Methods that may be used to perform this separation include, without limitation, sedimentation, floatation, filtration and membrane separation. Preferred is membrane separation.

A pump or gravity flow may be used to transfer the mixed liquor from the biological treatment step to the secondary separation step. A pump is required for external membranes but not necessarily for submerged membranes, in membrane separation.

The activated sludge 28 component may be divided into two portions, a portion that is recirculated back to the aeration tank for biological treatment (return activated sludge) and a portion that may be further treated and/or released the environment (waste activated sludge). The portion that is recirculated back to the biological treatment step may be aerated before it enters the aeration tank. The consistency of activated sludge after secondary separation may be between about 0.5% to about 1.2% solids, depending on separation technology. In some embodiments, if a membrane is used, it is in the 0.8 to 1.2% range. Methods of aerating the return activated sludge en route to the aeration tank include, without limitation, the use of air eductors or jet aeration. Alternatively or in addition, the mixed liquor in the aeration tank may be aerated with diffusers, aspirating impeller mixers, jet aeration pumps or from a compressed air/oxygen gas source.

In a preferred embodiment of the method, the return activated sludge is circulated back to the aeration tank through air eductors, and membrane separation is used for the secondary separation. In this preferred embodiment therefore, pressure from the membrane filtration step is available for the air eductors. For large plants, aspirating impeller mixers or blower/diffusers may be preferred.

Apparatus/System

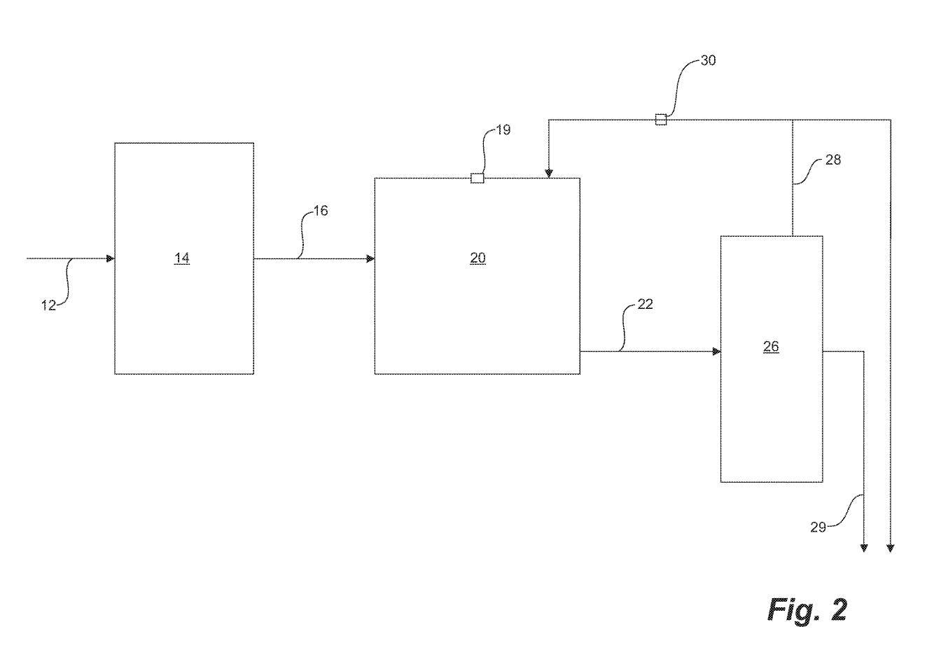

FIG. 2 shows a schematic of an embodiment of the wastewater treatment apparatus/system described herein. In the apparatus/system, wastewater 12 is delivered to a primary separator 14, which removes large suspended solids and particulate matter. The pre-treated wastewater stream 16 from the primary separator 14 is delivered via a conduit to a pressurized aeration tank 20, where it undergoes biological treatment. The pressurized aeration tank 20 is operated under low pressure, which pressure is maintained between about 1 psi and about 10 psi.

After biological treatment the mixed liquor 22 in the pressurized aeration tank is directed along a conduit to a secondary separator 26 which separates this mixture into an activated sludge component 28 and a clarified liquor effluent 29. All, or a portion of, the activated sludge component is recirculated to the pressurized aeration tank 20. This return activated sludge may be aerated before it is reintroduced into the aeration tank. The return activated sludge is delivered to the aeration tank 20 via a conduit, where it is added to the mixed liquor and aerated therewith.

Primary Separator

The primary separator 14 may be a screenings tank, a grit removal facility, a sedimentation tank, a floatation tank, or another type of primary separator known to persons of skill in the art. More than one primary separator may be used in the apparatus described herein.

Aeration Tank

Aeration tank 20 is a sealed pressure reservoir that is operated under low pressure to increase oxygen transfer efficiency, as compared to a non-pressurized tank. Since the aeration tank is pressured to below 15 psi, it does not need to be a certified pressure vessel.

Typically, aeration tanks used in the activated sludge process are operated at atmospheric pressure. The pressurized aeration tank 20 used in the methods and apparatus described herein operates at low pressure, between about 1 psi and 10 psi, preferably between about 3 psi and about 9 psi, most preferably between about 5 psi and about 7 psi. Operating at this slightly pressurized condition provides improved oxygen transfer efficiency, which increases the dissolved oxygen level. “Oxygen transfer efficiency” or “standard oxygen transfer rate” refers to the efficiency with which oxygen (O₂) dissolves into the mixed liquor. As is known, oxygen transfer efficiency increases as pressure increases. “Dissolved oxygen” (“DO” in mg O₂/L or ppm) is the amount of O₂ dissolved in the mixed liquor.

Aeration tank 20 may be of any shape. Contemplated shapes for the base of the tank include circular, oval, rectangular and square. The tank may be without limitation, ovoid, cylindrical or cuboid shaped. In a preferred embodiment the tank is cuboid shaped.

Preferred for use herein is a tank 20 with a square base, as a tank having a square base with width W can hold a greater volume of liquid than a cylindrical tank of diameter D, when W=D. Further, the top of the liquid inside a square tank has a greater surface area as compared to the liquid in a cylindrical tank (when W=D). A significant amount of foam accumulates at the top of the pressurized aeration tank, and it is important to leave a headspace above the liquid to accommodate this foam. Commonly, sewage treatment plants that use the activated sludge process include a separate equalization tank which acts as a holding tank to receive the raw flow and hold it until there is enough head space in the aeration tank to add more liquid. The gained surface area from the square aeration tank over the cylindrical tank may obviate the need for a separate equalization tank.

In other embodiments of the apparatus, pressurized aeration tank 20 may not have a square base. For example, existing aeration basins operated at atmospheric pressure may be circular, oblong, or rectangular tanks constructed of reinforced concrete. The apparatus and system described herein contemplate retrofitting of an existing aeration basin or tank, so that it can be pressurized and operated at a low pressure, to increase oxygen transfer efficiency. The means of retrofitting an existing tank so that it can operate at low pressure depends on type of water/wastewater treatment system in which the tank is operated. As currently used water/wastewater treatment facilities commonly use tanks which operate at atmospheric pressure, in many embodiments it is this type of tank that will be retrofitted. This may be accomplished, for example, by adding a gasketed cover to the tank, and otherwise sealing off areas where air/gas can escape to the atmosphere. The cover can be made, for example, of aluminum, steel or fiberglass. Tank structure should be evaluated, particularly if a steel tank is being retrofitted, to assess whether the tank can withstand the low pressure that will be applied. In some embodiments the walls of the tank may need to be reinforced.

The aeration tank may be pressurized to a pressure of between about 1 and about 10 psi by one or more pumps, air eductors, compressed air or oxygen, compressors, pressure boosting pumps, blowers and the like. A backpressure regulator 19 may be used to release pressure should the pressure exceed a maximum predetermined limit. Regulator 19 may be, for example a pressure control valve which functions as a back-up pressure control valve, or a pressure vacuum relief valve, which may be vented to another tank and/or to atmosphere.

Preferred for use herein to pressurize the aeration tank is a pump that transfers liquid from the primary separator, in combination with pressure from air eductors that receive fluid under pressure from a membrane separator.

Aeration/Agitation of Tank

Aeration and agitation of the pressurized aeration tank 20 may be accomplished by using a diffused air system, compressed air/oxygen, diffusers, aspirating impeller mixers, jet aeration pumps, or other methods known to those of skill in the art to aerate the mixed liquor. Existing water treatment facilities that are retrofitted with a low-pressure aeration tank may continue to use the previously established aeration methods, provided that pressure is regulated appropriately.

Preferred for use herein for aeration and agitation is an eductor system that draws air into a pressurized flow stream in combination with a plurality of multiplier nozzles located near the bottom of the tank. In some embodiments, a conventional blower may be used to introduce atmospheric air into the bottom of the pressurized aeration tank through diffusers. Conventional blowers typically have a maximum operating pressure of about 13.5 psi and therefore cannot be used in tanks that operate at a high pressure. However, they may be used in some embodiments of the methods and apparatus described herein, given that the aeration tank is operated at a pressure less than about 10 psi.

Secondary Separator

After biological treatment, the mixed liquor is separated into an activated sludge component and a clarified liquor component. The secondary separator 26 may be a membrane separator, a settling tank, a clarifier, an air flotation separator or another type of secondary separator known to persons of skill in the art. Preferred for use in the methods and apparatus herein is a membrane separator.

In embodiments not necessarily intended for use in a package plant, membrane separation may not be used, or may be used in conjunction with other treatment steps to clarify the effluent from the mixed liquor. For example, existing activated sludge wastewater treatment facilities that are retrofitted to have a low-pressure aeration tank may continue to use clarification methods already in place to separate the activated sludge from the clarified liquor.

After separation, the clarified liquor component 29 may be further treated or disposed of. All, or a portion, of the recovered activated sludge component 28 may be recirculated back to the pressurized aeration tank, the remainder being sent for further treatment or disposal.

The return activated sludge may be aerated by an aerator 30, on route back to the aeration tank, to create an aerated pressurized flow stream. In a preferred embodiment the aerator is one or more air eductors, which aerate the return activated sludge. Existing wastewater treatment facilities that are retrofitted to have a low-pressure aeration tank may continue to use aerators that are already in place to aerate the return activated sludge. This type of system could have a reduced capacity blower that is supplemented with additional air from an eductor or other means of air injection.

The return aerated pressurized flow stream may be circulated through injection nozzles at a high rate, before it enters the aeration tank. This high rate may be more than 4 times the rate of transfer flow from the screening tank to the pressurized aeration tank, and in some embodiments 4-10 times higher, 4-7 times higher or 4-5 times higher than the transfer flow rate.

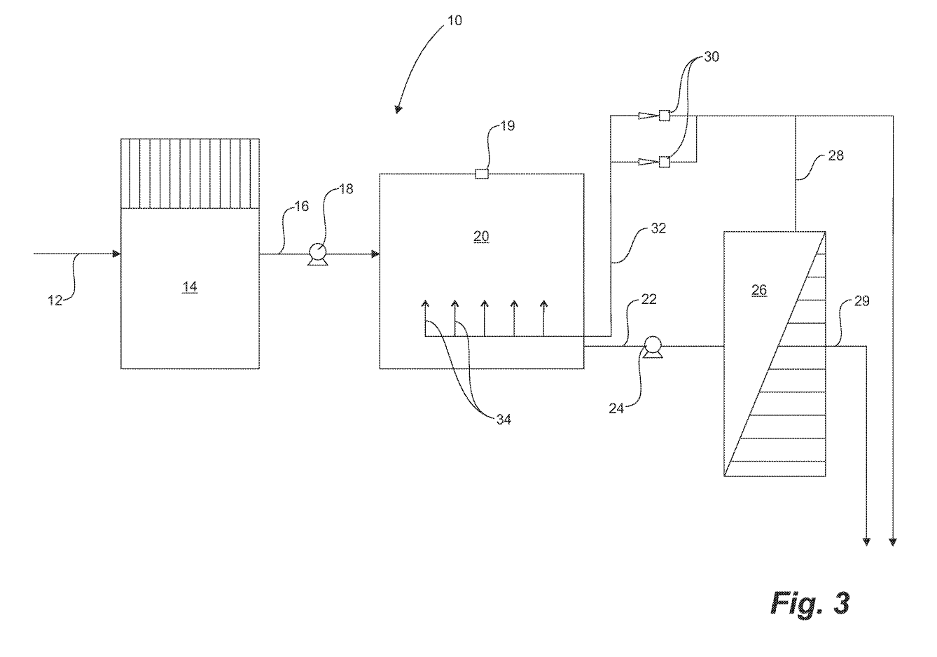

Having thus described the basic apparatus and method herein, specific embodiments will now be described. A specific embodiment used as a sewage treatment package plant is shown in the accompanying FIG. 3. This embodiment is designed to be mounted on a skid and transported to the site of usage. It is therefore designed to have a small footprint, to be low-maintenance, and to avoid the use of hazardous components such as compressed air/oxygen.

In the embodiment shown in FIG. 3, raw sewage 12 is delivered to a screenings tank 14, which removes large suspended solids and particulate matter such as rags, paper, plastics, metals and the like. The pre-treated sewage stream 16 exiting from the screenings tank is delivered via a conduit to a pressurized aeration tank 20, where it undergoes biological treatment. The pressurized aeration tank 20 is operated under low pressure, which pressure is generated, at least in part, by the action of at least one pump 18.

Pressurized aeration tank 20 shown in FIG. 3 has a square base, which is a preferred embodiment as it can hold a greater volume of liquid than can a cylindrical tank, for essentially the same footprint. The gained surface area from using a square aeration tank over the cylindrical tank enables combining of the volumes for equalization and treatment in one tank, again reducing footprint.

In the embodiment shown in FIG. 3, at least one pump 18 pumps the pre-treated sewage 16 into the aeration tank. The pump is selected to be able to provide sufficient pumping pressure to pressurize the aeration tank to the predetermined operating pressure range for the aeration tank. Air eductors 30 act as a secondary means for pressurizing or maintaining pressure in the aeration tank, while also drawing in oxygen from the atmospheric air. At least one backpressure regulator 19 releases pressure from the pressurized aeration tank should the pressure exceed a maximum predetermined limit.

Aeration and agitation of the mixed liquor 22 in the pressurized aeration tank 20 is accomplished by using a diffused air system. Air is introduced through porous diffusers or through air nozzles near the bottom of the tank. Air diffusers may be of different types, including without limitation bubble diffusers, tubular diffusers, jet aerators, aspirator devices and U-tubes.

In the embodiment shown in FIG. 3, a plurality of multiplier nozzles 34 located near the bottom of the aeration tank increase overall mixing efficiency by creating a vortex as the aerated liquid passes through the nozzle. In one embodiment, the nozzles are constructed in a conical shape that is designed to provide dynamic mixing under pressure which yields greater mass transfer.

A conventional blower may be used to introduce atmospheric air into the bottom of the pressurized aeration tank of FIG. 3, through a diffuser. Conventional blowers typically have a maximum operating pressure of about 13.5 psi. If the aeration tank is operated at a pressure of about 9.5 psi, adding about 2-3 psi for the weight of the liquid on top of the diffusers results in a total psi at the diffusers of about 11.5-12.5 psi, which is below the upper limit for operability of the blower.

In this embodiment a bleed branch with flow meter may be provided in the discharge air line of the blower to control the amount of air that is pumped to the pressurized aeration tank. The high temperature air from the blower may be routed through the membrane separation tank (see below), in a finned pipe. Heat can therefore be transferred to the treated water, which will enhance the screen and membrane cleaning. The cooled air may then be delivered to the diffuser from the inlet side of the aeration tank, as more air is needed at the inlet side of the tank.

After biological treatment the mixed liquor 22 in the pressurized aeration tank is pumped along a conduit via pump 24 to a membrane filtration separator 26, which separates this mixture into an activated sludge component 28 and a clarified liquor effluent 29. Membrane filtration has a smaller footprint than other means of clarifying the mixed liquor, such as for example, a settling tank, clarifier or air flotation separator.

The membrane is a semi-permeable and selective barrier that separates the water in the mixed liquor from the activated sludge in the mixed liquor. Several different membrane configurations may be used, for example plate-and-frame, spiral wound, tubular and hollow-fiber. Preferably the membrane is a self-cleaning membrane. In one embodiment, the membrane is a flat sheet membrane system where the filtration unit is external from any tankage.

In the embodiment of FIG. 3, at least a portion of the activated sludge component 28 recovered from the membrane filtration step is recirculated (returned) back to the pressurized aeration tank 20. The recirculation flow rate used depends on the pressure in other parts of the system and the specific requirements of the membrane system. For example, a minimum fluid pressure is needed to force the liquid through the membrane in the membrane separator, and a minimum fluid pressure and flow is needed in the piping to ensure that sufficient O₂ is drawn into the eductors 30 (see below) to aerate the return activated sludge. The flow rate of pump 24 is therefore determined by the flow rate needed to meet these specified pressures.

Along the recirculation path in the embodiment of FIG. 3, the return activated sludge passes through at least one air eductor 30, where it is aerated. Aerated return activated sludge 32 emitting from the eductor 30 is delivered to the aeration tank 20 via a conduit and is introduced into the tank though the distribution pipe located at the bottom of the tank. As noted above, the distribution pipe has a plurality of multiplier nozzles 34 attached thereto, through which the aerated activated sludge passes before entering the tank and mixing with its contents.

The at least one air eductor of the embodiment of FIG. 3 uses a Venturi effect to draw atmospheric air into the pressurized flow stream of the return activated sludge 28. In essence, a constriction in the eductor increases the velocity of the activated sludge 28 as it passes therethrough, decreasing pressure and creating a vacuum that draws air into this fluid stream. The eductor(s) is therefore a passive means of aerating the return activated sludge, bootstrapping off of the increased pressure of the fluid that is required by the membrane separation step. The use of eductors enables quieter operation of the plant, as no blowers or compressors are used.

Air eductors have a high recirculation rate, and provided that the motive fluid (in this case the return activated sludge 28) has a sufficient pressure, they can inject aerated liquid into a pressurized vessel. In the embodiment of the apparatus shown in FIG. 3, the clarified liquor being recirculated to the tank flows through the eductors at between about 15 to about 25 psi and is therefore injected into the pressurized aeration tank at a pressure of about 5 to about 7 psi.

An important feature of the wastewater treatment plant described in the embodiment shown in FIG. 3 is that the aeration tank is pressurized by the pumping of fluid into the tank. As discussed above, a first source of pressure in this embodiment is pump 18, which pumps the fluid into the aeration tank. A second source of pressure in the aeration tank is from the air eductor(s) 30. A pump 24 produces flow of the fluid stream necessary for the Venturi action in the educator that draws air into the stream. This stream is fed into the aeration tank and can contribute to the pressurization. The use of pumping and low pressure air, only, to pressurize the system is an important feature of this embodiment. As noted above, pressure in the aeration tank is limited to less than 10 psi by using backpressure regulators.

Another important feature of the wastewater treatment apparatus shown in FIG. 3 is that it reduces bubble size and increases contact time by replacing blowers and diffusers with eductors and injection/multiplier nozzles. The eductors draw air into a pressurized flow stream and the injection nozzles then further improve oxygen transfer efficiency by physically mixing air-rich activated sludge with the mixed liquor in the pressurized aeration tank. The combination of the eductors, injection nozzles and a high recirculation rate through the injection system leads to a higher pressure which increases oxygen transfer efficiency over what can be obtained with conventional blowers and diffusers, thereby increasing the dissolved oxygen available to the microbes.

The embodiment of the wastewater treatment plant shown in FIG. 3, therefore, has a number of potential advantages over other systems including that it has a small footprint, it is simple in design, energy consumption is low, it avoids using hazardous components such as compressed air/oxygen and high pressure, and it is low-maintenance.

### EXAMPLE

The following is a representative example of and embodiment of the low-pressure aeration wastewater treatment system described herein.

Raw sewage is fed into a screening tank through a 0.6 mm screen that has a capacity of 34 m³/hr. The tank has a volume of 0.8 m³ and comes with a gravity drain. The screened sewage from this tank is pumped by three inlet transfer pumps sized for a flow of 17 m³/hr with a discharge pressure of 16 psi. The screened sewage is transferred from the screening tank to the aeration tank which has a volume of 56 m³.

Air is introduced into the bottom of the aeration tank through four multiplier nozzles (Mazzei N45-DT mixing nozzles), which receive aerated liquid from two upstream eductors. The aeration tank is designed to be operated at up to 5-7 psi in the headspace when the water level is at a maximum and a level of dissolved oxygen is between about 1.5-2.5 mg/l.

Two backpressure regulators are used to maintain the pressure of the tank to between 5-7 psi, and a maximum of 9.5 psi. A motorized pressure control valve (AT Controls OC/OS series butterfly valve) is equipped as a back-up pressure control valve. A pressure vacuum relief valve Enardo Model 860 is equipped on the tank for safety protection. It is vented to screen and then to the atmosphere through the venting line of the screen.

The hydraulic residence time (HRT) in the aeration tank is 4.2 hours, with a 5 hour equalization time. The aeration tank can also be used to dampen peak flows and provide a means of diluting and distributing batch discharges of high-strength contaminant in the water.

The mixed liquor from the aeration tank is pumped by a variable frequency drive pump (Gorman-Rupp Model T4A3) to a membrane separator at a rate of 160 m³/hr and discharge pressure rating of 72 psi. The pressure of the fluid entering the membrane separator is about 70 psi, and exiting about 26 psi. The membrane separator is a Pleiade 2000 series membrane system manufactured by Orelis Environment. The system entails 75.6 m² of ultrafiltration membranes that are flat sheet and stacked between plates. The unit is an external membrane system that is not submerged in a tank containing fluid.

A portion of the liquid that passes through the membrane separator is recirculated back to the pressurized aeration tank. Generally, about 15 to 25 times more (on a volume basis) of the activated sludge is recirculated back to the aeration tank than is moved forward in the process for further treatment. The recirculated flow has a pressure of about 24 psi, and is fed into two 4″ eductors (Mazzei Model 4091 Air Injector) with suction check valves, inlet filter and discharge distribution nozzles. The air and liquid are mixed, and this mixture then flows through the outlet pipe section of the eductors with a pressure of about 10 psi, and is discharged back into aeration tank through the multiplier nozzles at a pressure of about 6 psi.

While the activated sludge wastewater treatment method and apparatus have been described in conjunction with the disclosed embodiments which are set forth in detail, it should be understood that this is by illustration only and the method and apparatus are not intended to be limited to these embodiments. On the contrary, this disclosure is intended to cover alternatives, modifications, and equivalents which will become apparent to those skilled in the art in view of this disclosure.

1. An apparatus for the biological treatment of wastewater in an activated sludge process comprising:
a) a primary separator that produces a pretreated wastewater with large solids removed;
b) a conduit for transporting the pretreated wastewater to a pressurized aeration tank which has a headspace pressure of between about 1 and about 10 psi;
c) means for aerating and agitating a mixed liquor in the aeration tank; and
d) a conduit for transporting the mixed liquor to a secondary separator, for separating the mixed liquor into an activated sludge component and a clarified liquor component.

2. The apparatus of claim 1 wherein the aeration tank has a rectangular or square base.

3. The apparatus of claim 2 wherein the aeration tank is cuboid.

4. The apparatus of claim 1, wherein the aeration tank is pressurized to the headspace pressure by a pump that pumps the pretreated wastewater into the aeration tank.

5. The apparatus of claim 4 wherein the primary separator is a screening tank.

6. The apparatus of claim 4, wherein the secondary separator is a membrane separator, and further comprising a pump that pumps the mixed liquor to the membrane separator.

7. The apparatus of claim 1, further comprising a return path along which at least a portion of the activated sludge component is recirculated back to the aeration tank.

8. The apparatus of claim 7 wherein the return path comprises at least one air eductor that aerates the portion of the activated sludge component that is recirculated back to the aeration tank.

9. The apparatus of claim 8, wherein the means for aerating and agitating a mixed liquor in the aeration tank is a diffused air system.

10. The apparatus of claim 9, wherein the diffused air system further comprises at least one multiplier nozzle.

11. A method for the biological treatment of wastewater using the activated sludge process, which comprises the steps of:
a) delivering a pretreated wastewater stream into a pressurized aeration tank that has a headspace pressure of between about 1 and about 10 psi;
b) aerating and agitating a mixed liquor in the aeration tank; and
c) maintaining the mixed liquor in the pressurized aeration tank for a period of time sufficient for microorganisms in the wastewater to consume soluble and colloidal organics, nutrients and other substances in the mixed liquor.

12. The method of claim 11 wherein the aeration tank has a rectangular or square base.

13. The method of claim 12 wherein the aeration tank is cuboid.

14. The method of claim 11, further comprising the steps of: (a) generating the headspace pressure in the tank by pumping the wastewater stream into the aeration tank, and (b) maintaining the headspace pressure at less than about 10 psi with at least one backpressure regulator.

15. The method of claim 11 further comprising the steps of:
a) after the period of time, transporting the mixed liquor from the pressurized aeration tank to a secondary separator;
b) separating the mixed liquor to produce an activated sludge component and a clarified liquor effluent;
c) aerating at least a portion of the activated sludge component to produce aerated activated sludge; and
d) delivering the aerated activated sludge to the pressurized aeration tank.

16. The method of claim 15 wherein the portion of the activated sludge is aerated with at least one air eductor.

17. A method for the biological treatment of sewage using the activated sludge process, which comprises the steps of:
a) passing primary raw sewage through a screening tank to produce a pretreated sewage stream;
b) pumping the pretreated sewage stream into an aeration tank that is pressurized to a pressure of between about 1 and about 10 psi;
c) aerating and agitating a mixed liquor in the aeration tank;
d) discharging the mixed liquor from the aeration tank;
e) separating the discharged mixed liquor into an activated sludge component and a clarified liquor component;
f) aerating at least a portion of the activated sludge component, to form an aerated activated sludge; and
g) delivering the aerated activated sludge to the aeration tank.

18. The method of claim 17, wherein the step of separating the discharged mixed liquor is performed by membrane separation.

19. The method of claim 17, wherein the step of aerating a portion of the activated sludge component is performed by directing the portion of the activated sludge through at least one air eductor.

20. The method of claim 20 wherein the aerated activated sludge is introduced into the aeration tank through at least one multiplier nozzle disposed in the aeration tank.
